(19) United States
(12) Patent Application Publication
(10) Pub. No.: US 2014/0181362 A1
(43) Pub. Date: Jun. 26, 2014

(54) ELECTRONIC DEVICE FOR STORING DATA ON PRAM AND MEMORY CONTROL METHOD THEREOF

(71) Applicant: Gyu Sang Choi, Suseong-gu Daegu (KR)

(72) Inventor: Gyu Sang Choi, Suseong-gu Daegu (KR)

(73) Assignee: Industry Academic Cooperation Foundation of Yeungnam University, Gyeongsan-si, Gyeongsangbuk-do (KR)

(21) Appl. No.: 14/239,122

(22) PCT Filed: Aug. 17, 2012
(86) PCT No.: PCT/KR2012/006581

§ 371 Date: Feb. 14, 2014

(30) Foreign Application Priority Data
Aug. 18, 2011 (KR) 10-2011-0081991

(51) Int. Cl. G06F 3/06

(52) U.S. Cl. CPC G06F 3/0679; G06F 3/0604; G06F 3/0638
USPC 711/102

(57) ABSTRACT

The present disclosure relates to an electronic device for storing data on PRAM and a memory control method thereof The electronic device of the present disclosure comprises: a nonvolatile memory in which data is stored; a volatile memory in which an address conversion table of a nonvolatile memory is stored; and a controller that stores data on a nonvolatile memory by referencing an address conversion table of a nonvolatile memory stored on a volatile memory. Due to this, a nonvolatile memory having limitative number of write and read such as PRAM can be operated more effectively.

### CROSS-REFERENCE TO RELATED APPLICATION

This application claims priority under 35 U.S.C. §119 to Korean Patent Application No. 10-2011-0081991 filed on Aug. 18, 2011, the disclosure of which is hereby incorporated by reference in its entirety.

### BACKGROUND

1. Field

The present disclosure relates generally to controlling a memory. More particularly, it concerns a technique of recording data on a memory having limitative number of write, and controlling the memory during the aforesaid process.

2. Description of Related Art

So far throughout the recent decades, it was general to use a storage system based on a HDD (Hard Disk Drive) for a computer. However, these days, changes have been occurred because of a NAND Flash Memory.

The NAND Flash Memory has been increasingly used for a computer/embedded system due to its advantageous of high performance, low power consumption, high reliability, small form factor, in comparison with HDD.

Yet, a market share of the NAND Flash Memory is still low in comparison with that of the HDD. This is because the NAND Flash Memory is high priced compared to the existing HDD and has a similar performance therewith at a specific operation such as a random write.

The high price problem of the NAND Flash Memory is in overcoming through configuring mass storage of the NAND Flash Memory, and price decline through an MLC (Multi-level Cell); however, still, it is a high priced storage device for the consuming public, in comparison with the HDD.

Many researches have been actively conducted to expand a market share of the NAND flash memory; nevertheless, there were limitations for improving its performance because of a physical characteristic of the NAND flash memory (proposal of reclaiming an erasure operation).

In this regard, many companies or laboratories have conducted researches regarding a new nonvolatile ram device that will replace a NAND flash memory. In return, nonvolatile ram devices such as PRAM, FRAM have been developed, and may researches for its commercialization have been still carried out.

Such nonvolatile rams are new nonvolatile memory device that overcame disadvantages of the existing NAND flash memory, and are expected to be used as a next-generation storage device that replaces the NAND flash memory in the future.

Among many nonvolatile rams, PRAM is expected to be a strong nonvolatile ram that will replace the NAND flash memory. Further, many companies specialized in semiconductor proceed with researches for commercialization by investing an enormous amount of time and effort. The reason why PRAM is considered to replace the NAND flash memory is set forth below.

PRAM is feasible for a rewrite, regardless of deleting existing data, unlike the NAND flash memory. Thus, it is not necessary that an erasure calculation is preceded for a rewrite operation. The erasure calculation for the rewrite operation is a calculation which influences most negatively on the performance of the NAND flash memory, and is implemented per block unit, of which calculation time is very long approximately 1 ms.

Therefore, due to the erasure calculation, the reason why the NAND flash memory cannot show a performance higher than HDD, at a specific operation such as a random write, may be suggested. However, a rewrite is feasible without such erasure calculation, in the PRAM, thus, a high performance can be shown in comparison with the NAND flash memory as well as HDD.

Further, the number of read and write of the PRAM is approximately 10⁶, and the PRAM has a lifespan that is approximately ten times longer than the NAND flash memory.

However, when compared to the HDD having unlimited number of write and read, the number of write and read of the PRAM would be regarded as being limitative. This acts as an obstructive factor in regard to PRAM being adopted to a storage system

### PRIOR ART

### Patent Literature 1

Korean Patent Laid-Open Publication No. 2010-0126069

### DISCLOSURE

### Technical Problem

In view of above, it is an object of the present disclosure to provide a memory control method for more effectively operating a nonvolatile memory having limitative number of write and read such as PRAM, and an electronic device using thereof.

### Technical Solution

According to an embodiment of the present disclosure designed to accomplish the above object, there is provided an electronic device comprising: a nonvolatile memory in which data is stored; a volatile memory in which an address conversion table of the nonvolatile memory is stored; and a controller that stores data on the nonvolatile memory by referencing the address conversion table of the nonvolatile memory stored on the volatile memory.

On the nonvolatile memory, a first table that is referenced to convert a physical address of the nonvolatile memory to a logical address is stored; and the controller is characterized of generating a second table that is referenced to convert the logical address to the physical address of the nonvolatile memory by using the first table, and storing on the volatile memory.

The controller is characterized of generating the second table when the electronic device is booted, and storing on the volatile memory.

The second table stored on the volatile memory is deleted when power supply of the electronic device is shut off.

The nonvolatile memory is a PRAM(Phase-change Random Access Memory), the controller is characterized of storing data on the PRAM per page unit, and the page may be made up of a byte unit.

According to another embodiment of the present disclosure, there is provided an electronic device comprising: a nonvolatile memory in which data is stored; a volatile memory in which an address conversion table of the nonvolatile memory is stored; and a controller that stores data on the nonvolatile memory per page unit by referencing the address conversion table of the nonvolatile memory stored on the volatile memory. The controller is characterized of storing data on page having minimum number of write among all pages.

The controller is characterized of converting a physical address regarding page in which the number of write of the nonvolatile memory is above a standard to another physical address.

The nonvolatile memory is a PRAM(Phase-change Random Access Memory).

According to another embodiment of the present disclosure, there is provided a memory control method comprising: storing an address conversion table of a nonvolatile memory on a volatile memory; and storing data on the nonvolatile memory by referencing an address conversion table of the nonvolatile memory stored on the volatile memory.

The storing the address conversion table is characterized of storing a first table that is referenced to convert a physical address of the nonvolatile memory to a logical address on the nonvolatile memory, and storing a second table that is referenced to convert the logical address of the nonvolatile memory to a physical address on the volatile memory.

The second table is generated when an electronic device is booted, and stored on the volatile memory; and the second table stored on the volatile memory is deleted when power supply of the electronic device is shut off.

The nonvolatile memory is a PRAM(Phase-change Random Access Memory), and the storing the data is characterized of storing data on the PRAM per page unit, on page having minimum number of write among all pages.

### Effect

As explained above, according to the present disclosure, a nonvolatile memory having limitative number of write and read such as PRAM can be more effectively operated. Specifically, in the present disclosure, by a technical means of converting an address, an address conversion table of PRAM is referenced by storing on another memory. In this regard, a rapid deterioration of meta data region of PRAM due to frequent reading of PRAM to reference an address conversion table when implementing read and write of data in PRAM, can be prevented.

Further, according to the present disclosure, by means of equipartition technique, a region having small number of write may be adaptively induced to be used, rather than a region having large number of write. In this regard, data region of PRAM is equally used, such that a reduction of an actual storage space of PRAM due to precedent deterioration of a part of data region, can be prevented.

### BRIEF DESCRIPTION OF THE DRAWINGS

FIG. 1 illustrates an internal block diagram of an electronic device according to an embodiment of the present disclosure.

FIG. 2 is a view provided to explain a technique of converting an address, which is implemented by the electronic device illustrated in FIG. 1.

FIG. 3 is a view provided to explain an equipartition technique, which is implemented by the electronic device illustrated in FIG. 1.

### DETAILED DESCRIPTION OF THE EMBODIMENTS

Reference will now be made in detail to the embodiments of the present disclosure, examples of which are illustrated in the accompanying drawings.

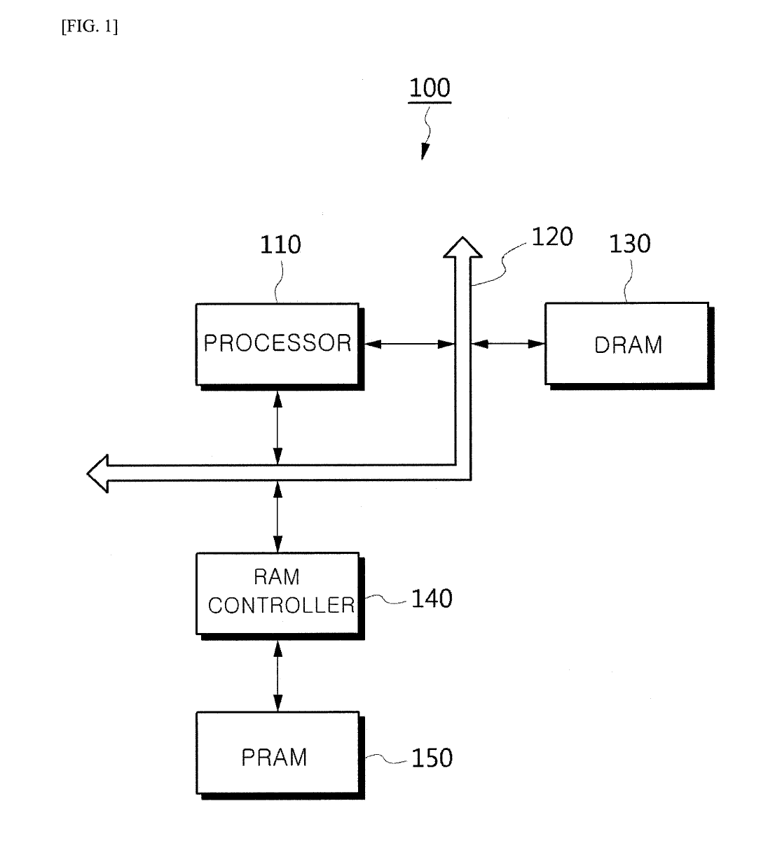

FIG. 1 illustrates an internal block diagram of an electronic device 100 according to an embodiment of the present disclosure. An electronic device 100 applicable to the present disclosure is a storage medium which stores data, and uses a PRAM(Phase-change Random Access Memory) 150. The PRAM may be used as a term of PCM or PCRAM.

Unlike HDD(Hard Disk Drive) having unlimited write and read, in order to solve a durability problem of PRAM 150 having limited number of write, the aforementioned electronic device 100 adopts a technique of converting an address and an equipartition technique, which are optimized for PRAM 150.

The technique of converting an address optimized for PRAM 150 is a technique configured to minimize an increase of the number of read of the PRAM 150, in the process of referencing the address conversion table for converting a logical address to a physical address of PRAM 150.

The equipartition technique optimized for PRAM 150 is a technique by which data region of PRAM 150 having limitative maximum number of write is equally used.

The electronic device 100 adopting such techniques is, as illustrated in FIG. 1, constructed in such a manner that a processor 110 controlling a general function implementation of the electronic device 100, a RAM controller 140, DRAM(Dynamic Random Access Memory) 130, PRAM 150 are electrically connected through a bus 120.

Although it is not illustrated in FIG. 1, the electronic device 100 may further comprise I/O devices and adjuvant devices, which are necessary for a natural function implementation.

DRAM 130 is a volatile memory, and is a space where necessary data for implementing a controlling of the electronic device 100 by a processor 110 is temporarily stored; PRAM 150 is a nonvolatile memory, and is a space where data that should not be erased even if power supply of electronic device 100 is shut off, is stored semipermanently.

A RAM controller 140 implements write and read of data regarding PRAM 150. Specifically, in accordance with an exemplary embodiment of the present disclosure, a RAM controller 140 implements write and read operations of certain size data, which is stored on PRAM 150.

A Size of data of PRAM 150 in the exemplary embodiment of the present disclosure is a size that can be treated by a RAM controller 140 at one time, and may be randomly set up per a byte unit, upon a choice of a skilled person in the art. Therefore, the size may be the same as that of a block or a page of flash memory. More preferably, the size may be set up to be smaller than a page of a flash memory. For example, it may be set up as 512 bytes, 2K bytes, 4K bytes.

Next, according to an exemplary embodiment of the present disclosure, a technique of converting an address and an equipartition technique, which are optimized for PRAM 150 applied to an electronic device, will be described.

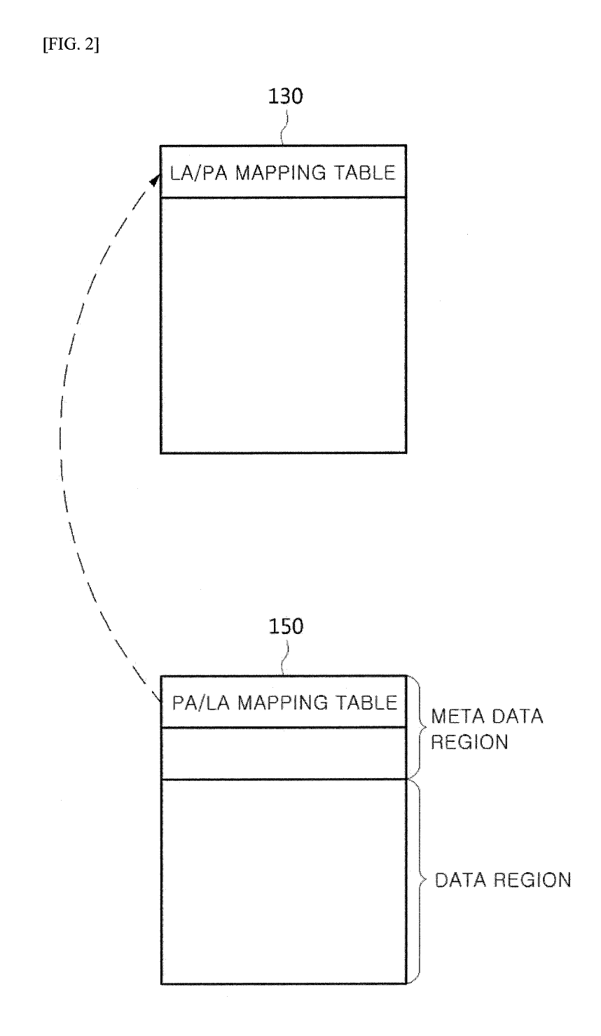

First, embodiments of the present disclosure are characterized in that a RAM controller 140 uses a storage space of DRAM 130, in the process of write and read of data regarding PRAM 150. This is in accordance with a technique of converting an address to reduce the number of read regarding PRAM 150 of which performance becomes deteriorated as the number of read increases, and they will be in detail described with reference to FIG. 2 hereinafter.

FIG. 2 is a view provided to explain a technique of converting an address, which is implemented by the electronic device 100 illustrated in FIG. 1.

As illustrated in bottom FIG. 2, PRAM 150 is divided into meta data region and data region. Data region is a region where an actual data is stored, and meta data region is a table where an address conversion table that is referenced to store data on data region is stored.

According to an illustration of FIG. 2, it would be understood that PA/LA mapping table that is referenced to convert a PA (Physical Address) of PRAM 150 to an LA (Logical Address) is stored on meta data region of PRAM 150.

Further, according to an upper illustration of FIG. 2, it would be understood that LA/PA mapping table to which PA/LA mapping table is converted, is stored on DRAM 130. Converting table as illustrated in FIG. 2 is implemented by a RAM controller 140.

That is, a RAM controller 140 generates LA/PA mapping table by converting PA/LA mapping table of PRAM 150, and stores the generated LA/PA mapping table on DRAM 130.

In an exemplary embodiment of the present disclosure, operation of converting and storing table as above may be performed when booting an electronic device 100. Since DRAM 130 is a volatile memory; when power supply of the electronic device 100 is shut off, LA/PA mapping table stored on DRAM 130 is deleted.

Converting PA/LA mapping table stored on PRAM 150 and storing on DRAM 130 as being converted LA/PA mapping table are for preventing meta data region of PRAM 150 from deterioration, which is caused by frequent reading of PRAM 150 to reference an address conversion table when implementing read and write of data.

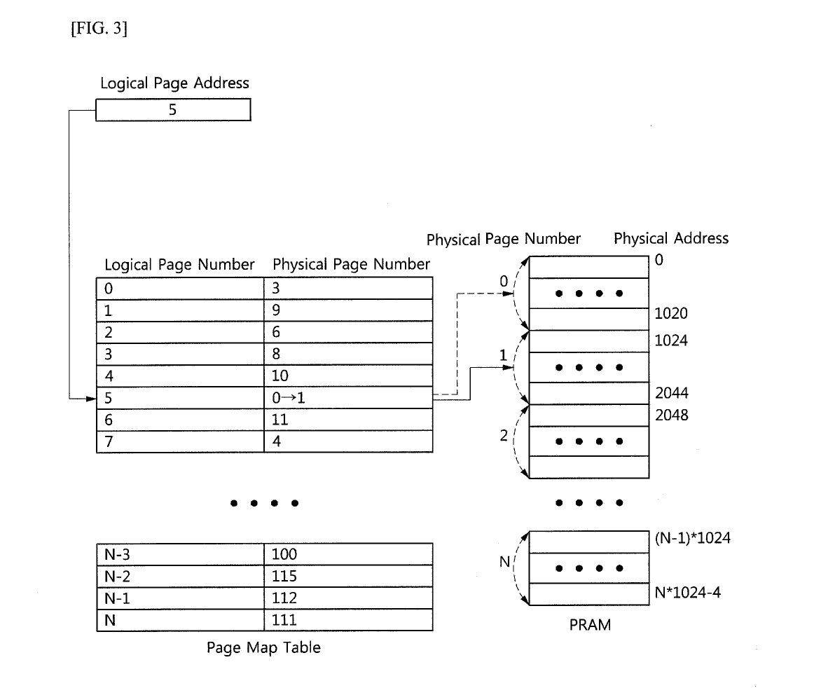

Hereinafter, a process of managing address conversion tables in order for data region of PRAM 150 to be used equally will be in detail described with reference to FIG. 3. FIG. 3 is a view provided to explain an equipartition technique, which is implemented by an electronic device illustrated in FIG. 1.

At left of FIG. 3, LPA(Logical Page Address)/PPA(Physical Page Address) mapping table is illustrated; at right of FIG. 3, data region of PRAM 150 is illustrated conceptually.

In LPA/PPA mapping table illustrated in FIG. 3, an equipartition technique according to an exemplary embodiment of the present disclosure is applied, and 0 of PPA corresponding to 5 of LPA is changed to 1. Accordingly, data in which write is ordered to 5 of LPA, is stored on a region where PPA is not 0 but 1, in data region of PRAM 150; and PA therefor is in a range of 1024 to 2044.

Conversion implemented as illustrated in FIG. 3 results from the fact that the number of write regarding a region where PPA is 0 (PA ranging from 0 to 1020) is relatively many (e.g., over 120% of an average number of write regarding all regions).

A region where PPA is 1 (PA ranging from 1024 to 2044), which is a converted region, corresponds to a region where the number of write is relatively small (e.g., under 80% of an average number of write regarding all regions).

Converting an address conversion table as illustrated in FIG. 3 is implemented by a RAM controller 140. To this end, the RAM controller 140 further implements managing the number of read and write.

In an exemplary embodiment of the present disclosure, in order for the managing the read and write to be implemented on the basis of PA, it is intended that not LA/PA mapping table that an entry of LA precedes an entry of PA but PA/LA mapping table that an entry of PA precedes an entry of LA is stored on meta data region of PRAM 150.

Meanwhile, in FIG. 3, only content of LA/PA mapping table is converted; however, converting the same content can be reflected in PA/LA mapping table as well. That is, all address conversion tables stored on DRAM 130 and PRAM 150 are converted by a RAM controller 140.

On the other hand, if converting mapping table is generated too frequently, a speed of deterioration of PRAM 150 would be fast. In this regard, it is preferable that converting an address conversion table is implemented as cycle arrives after setting up a cycle.

Due to the converting the address conversion table as described above, a region having small number of write may be adaptively induced to be used, rather than a region having large number of write. In this regard, data region of PRAM 150 is equally used, such that a reduction of an actual storage space of PRAM 150 due to precedent deterioration of a part of data region, can be prevented.

As set forth above, a technique of converting an address and an equipartition technique, which are so optimized for PRAM 150 as to solve a durability problem of PRAM 150, is described in detail. Such techniques may be selectively realized. Further, such techniques may be realized as a module configuring software such as hardware, firmware, and also a module configuring software like an internal module of operation system.

As explained above, according to the present disclosure, a nonvolatile memory having limitative number of write and read such as PRAM can be operated more effectively. Specifically, in the present disclosure, by a technical means of converting an address, an address conversion table of PRAM is referenced by storing on other memories. In this regard, a rapid deterioration of meta data region of PRAM due to frequent reading of PRAM 150 to reference an address conversion table when implementing read and write of data, can be prevented.

Additionally, according to the present disclosure, by means of equipartition technique, a region having small number of write may be adaptively induced to .be used, rather than a region having large number of write. In this regard, data region of PRAM is equally used, such that a reduction of an actual storage space of PRAM due to precedent deterioration of a part of data region, can be prevented.

Meanwhile, PRAM 150 mentioned in above embodiment is just an example of a nonvolatile memory. Therefore, in the electronic device 100 assumed in above embodiment, PRAM 150 can be replaced with other different kinds of nonvolatile memories, and even in this case, a technical thought of the present disclosure can be applied.

The description of the exemplary embodiments of the present inventive concept is intended to be illustrative, and not to limit the scope of the claims. A skilled person in the art may invent various changes, modifications, and equivalents of the systems, apparatuses and/or methods described herein. Accordingly, other implementations are within the scope of the following claims.

We claim:

1. An electronic device comprising:
a nonvolatile memory in which data is stored;
a volatile memory in which an address conversion table of the nonvolatile memory is stored; and
a controller that stores data on the nonvolatile memory by referencing the address conversion table of the nonvolatile memory stored on the volatile memory.

2. The electronic device of claim 1,
wherein on the nonvolatile memory, a first table that is referenced to convert a physical address of the nonvolatile memory to a logical address is stored, and
wherein the controller is characterized of generating a second table that is referenced to convert the logical address to the physical address of the nonvolatile memory by using the first table, and storing on the volatile memory.

3. The electronic device of claim 2,
wherein the controller is characterized of generating the second table when the electronic device is booted, and storing on the volatile memory.

4. The electronic device of claim 3,
wherein the second table stored on the volatile memory is deleted when power supply of the electronic device is shut off.

5. The electronic device of claim 1,
wherein the nonvolatile memory is a PRAM(Phase-change Random Access Memory),
wherein the controller is characterized of storing data on the PRAM per page unit, and
wherein the page is made up of a byte unit.

6. An electronic device comprising:
a nonvolatile memory in which data is stored;
a volatile memory in which an address conversion table of the nonvolatile memory is stored; and
a controller that stores data on the nonvolatile memory per page unit by referencing the address conversion table of the nonvolatile memory stored on the volatile memory,
wherein the controller is characterized of storing data on page having minimum number of write among all pages.

7. The electronic device of claim 6,
wherein the controller is characterized of converting a physical address regarding page in which the number of write of the nonvolatile memory is above a standard to another physical address.

8. The electronic device of claim 7,
wherein the nonvolatile memory is a PRAM(Phase-change Random Access Memory).

9. A memory control method comprising:
storing an address conversion table of a nonvolatile memory on a volatile memory; and
storing data on the nonvolatile memory by referencing an address conversion table of the nonvolatile memory stored on the volatile memory.

10. The memory control method of claim 9,
wherein the storing the address conversion table is characterized of storing a first table that is referenced to convert a physical address of the nonvolatile memory to a logical address on the nonvolatile memory, and storing a second table that is referenced to convert the logical address of the nonvolatile memory to a physical address on the volatile memory.

11. The memory control method of claim 10,
wherein the second table is generated when an electronic device is booted, and stored on the volatile memory; and the second table stored on the volatile memory is deleted when power supply of the electronic device is shut off.

12. The memory control method of claim 9,
wherein the nonvolatile memory is a PRAM(Phase-change Random Access Memory), and
wherein the storing the data is characterized of storing data on the PRAM per page unit, on page having minimum number of write among all pages.
